(19) United States
(12) Patent Application Publication
(10) Pub. No.: US 2026/0243025 A1
(43) Pub. Date: Aug. 20, 2026

(54) METHOD AND PLANT FOR MAKING A CELLULOSE-BASED WEB

(71) Applicant: COMAS - COSTRUZIONI MACCHINE SPECIALI - S.P.A., Silea (Trevis) (IT)

(72) Inventor: Alessandro GRANZOTTO, Silea (Treviso) (IT)

(21) Appl. No.: 19/471,147

(22) PCT Filed: Mar. 25, 2024
(86) PCT No.: PCT/IB2024/052828

§ 371 Date: Sep. 30, 2025

(30) Foreign Application Priority Data
Mar. 31, 2023 (IT) 102023000006300

(51) Int. Cl. D21H 19/52; B27N 1/00; B27N 3/02; B27N 3/04; B27N 3/18

(52) U.S. Cl. CPC D21H 19/52; B27N 1/00; B27N 3/02; B27N 3/04; B27N 3/18

(57) ABSTRACT

A method for making a continuous web from cellulose-based material, includes a step of feeding a first quantity of at least one liquid and a second quantity of dry product in fibre, ground and/or powdered form into a mixing space of a kneader, where the dry product comprises cellulose. The method includes a step of mixing the second quantity of dry product with the first quantity of liquid in the kneader to obtain a mixture, followed by a step of forming a continuous web from the mixture. In particular, the step of forming a continuous web is accomplished by performing a first step of laminating the mixture via a first pair of rollers to obtain a laminated semi-finished product, and a second step of laminating the laminated semi-finished product via a second pair of rollers to obtain a continuous web.

### TECHNICAL FIELD

This invention addresses the tobacco industry and relates to a machine and a method for making a continuous web from cellulose-based material.

### BACKGROUND ART

Known in the prior art is a method for making a web of reconstituted material from a plant-based mixture, as described in patent application WO2020/058814 in the name of the present Applicant.

The method for making the web, as described in that patent application, is characterized by the preparation of a mixture obtained by mixing tobacco particles with at least one liquid component, such as water, for example, where the mixture is divided into predetermined portions and then subjected to a succession of distinct laminating steps to obtain the web of tobacco which is then dried.

In particular, that application describes performing a first laminating step via a unit comprising a lobe feeder and at least one pair of vertical laminating cylinders, followed by a step of multistage lamination via a plurality of pairs of horizontal rollers mounted in series so as to gradually reduce the thickness of the web.

Although this technology is well suited for the aforesaid type of mixture, the Applicant has noticed that it is not optimized for implementing the process of forming the reconstituted material from a different kind of plant-based mixture, having different physical and mechanical properties, such as, for example, a mixture characterized by having a significant percentage content of cellulose and a reduced content of liquids, and in particular, without tobacco. In effect, on account of the physical and mechanical properties of this kind of mixture (for example, viscosity, elasticity, density, tenacity, expandability, adhesiveness, colloidality, and others), plant and machinery used for the aforesaid process have critical aspects which make them not entirely suitable for working with mixtures of this kind.

The different type of plant material used (basically, cellulose instead of tobacco) produces mechanical properties which make the mixture unsuitable for processing in the same way as tobacco is processed.

In this context, the technical purpose of this invention is, therefore, to provide a method for making a continuous web of cellulose-based material which is free of the disadvantages of the prior art.

### DISCLOSURE OF THE INVENTION

This invention therefore has for an aim to provide a method for making a continuous web of cellulose-based material which is capable of producing a finished product of satisfactory quality.

In the context of the same technical purpose, another aim of the invention is to provide a method for making a continuous web of cellulose-based material which can be implemented on the specific material identified using compact and structurally simplified plant.

The above aims are substantially achieved by a method according to the features set out in appended claim 1 and/or in one or more of the claims dependent thereon.

### BRIEF DESCRIPTION OF DRAWINGS

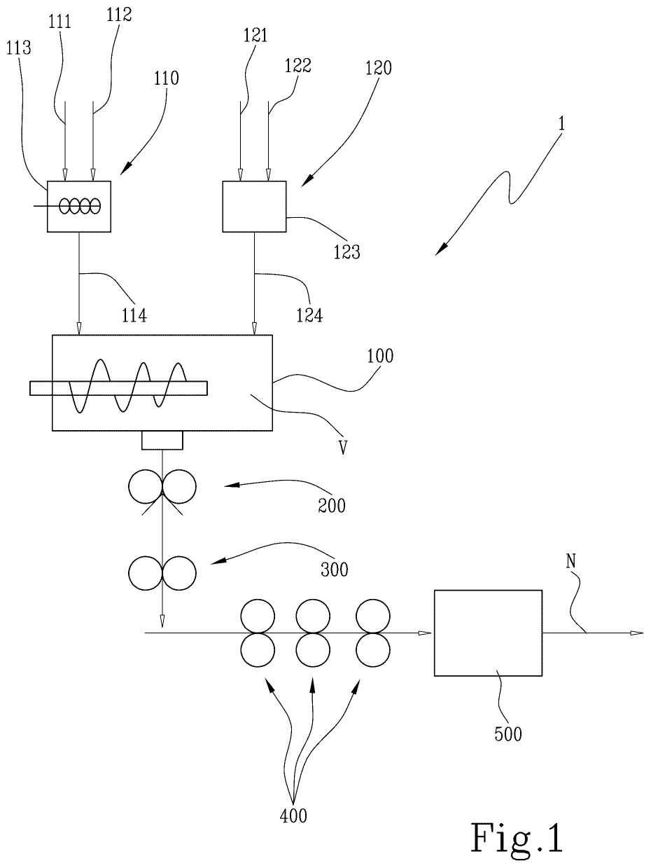

Further features of the invention and its advantages are more apparent in the following exemplary, hence non-limiting description of a preferred but non-exclusive embodiment of a method for making a continuous web of cellulose-based material, as illustrated in FIG. 1, which shows, in a schematic view, an exemplary, hence non-limiting, preferred embodiment of a plant for implementing a method for making a continuous web of cellulose-based material according to the invention.

### DETAILED DESCRIPTION OF PREFERRED EMBODIMENTS OF THE INVENTION

In this disclosure, the expression “cellulose-based” is used to mean a reconstituted material obtained by mixing at least one dry component containing cellulose with at least one liquid component, such as water, for example. Preferably, but without limitation, the material comprises a mixture of components in the dry state, at least one of which is cellulose-based.

The method is described below in an embodiment of it with reference to a plant used to implement it, denoted by the reference numeral 1 in the accompanying drawing.

According to this invention, the method comprises feeding a first quantity of at least one liquid into a mixing space V of a kneader 100 and feeding a second quantity of dry product in fibre, and/or ground or powdered form into the mixing space V of the kneader 100, where the at least one dry product comprises cellulose in fibre, and/or ground or powdered form.

The kneader 100 may be of any kind provided it is capable of mixing the solid and liquid components. Preferably, the kneader 100 operates in “batch” mode and may be, for example, of the tilting type.

As for the step of feeding the first quantity, the expression “at least one liquid” is used to mean mainly water and, preferably, at least one additional component preferably premixed with the water. In particular, the additional component comprises one or more between glycerine, nicotine, lactic acid, propylene glycol, colourants, at least one binding agent. In order to feed the first quantity of at least one liquid, the plant 1 comprises a feed line 110 for feeding the at least one liquid and connected to the kneader 100.

If there are one or more of the aforesaid additional components, the feed line 110 may comprise a plurality of feed branches 111, 112, each used for one particular liquid component, and an intermediate tank 113, operatively disposed upstream of the kneader 100 and connected to the kneader 100 by a delivery branch 114. Inside the intermediate tank 113, the water and the additional components are preloaded and predosed. Preferably, the intermediate tank 113 is provided with mixing means, configured for mixing the water with the one or more additional components.

In a preferred embodiment, the method comprises feeding glycerine (in a quantity such as to constitute a percentage of the final weight of the mixture of between 30% and 45%, preferably between 35% and 40% and, more preferably, around 37%) and water (in a quantity such that the final moisture content is between 15% and 35%, preferably between 20% and 30% and, more preferably, around 25%). Preferably, any other additional components in a liquid state are fed in a total quantity not greater than 10% of the final weight of the mixture.

In a preferred embodiment of the method according to the invention, the step of feeding the first quantity is accomplished by feeding the water and the additional liquid components into the intermediate tank 113 in two or more separate and distinct sub-steps, while the intermediate tank 113 continuously performs the aforesaid step of mixing. In other words, the water and the one or more additional liquid components may be fed into the intermediate tank 113 in a given order and/or according to a given fractionation.

Preferably, according to an aspect of the invention, feeding the first quantity of the at least one liquid is carried out at least partly, preferably entirely, before feeding the second quantity of the at least one dry product, as will become clearer as this description continues.

As for the step of feeding the second quantity, the expression “at least one dry product” is used to mean mainly cellulose (in the required forms) and, if necessary, at least one additional dry product, for example, in fibre, ground and/or powdered form, preferably in reduced quantities. In particular, the additional dry product may comprise tobacco, cocoa, hemp, aromatic leaves or other products.

In the preferred embodiment, the cellulose (the first dry product) is fed in a quantity such as to constitute a percentage of the final weight of the mixture of between 40% and 80%, preferably between 40% and 65%, more preferably between 50% and 60% and, still more preferably, around 55%.

Preferably, the mixtures concerned are mixtures having a total weight of between 20 kg and 100 kg, more preferably between 40 kg and 80 kg.

In order to feed the second quantity of at least one dry product, the plant 1 comprises a feed line 120 for feeding the at least one liquid and connected to the kneader 100.

If there are one or more of the additional dry products, the feed line 120 may comprise a plurality of feed branches 121, 122, each used for one particular dry product. The feed line 120 may also comprise an intermediate tank 123, operatively disposed upstream of the kneader 100 and connected to the kneader 100 by a delivery branch 124, where the powdered cellulose and the additional products are preloaded and predosed.

The method then comprises a step of mixing the second quantity of dry product with the first quantity of liquid in the kneader 100 to obtain a mixture. In particular, the mixture obtained has a moisture content of between 10% and 65%, preferably between 15% and 35%, more preferably between 20% and 30% and still more preferably, approximately 25%, and a cellulose content of between 40% and 80%, preferably between 50% and 60%, and more preferably, approximately 55%.

In particular, it was found that the mixture produced by the step of mixing has a sandy and/or grainy texture, with a particle size of between 1 and 6 mm. More specifically, the mixture has a density of between 250 Kg/m³ and 500 Kg/m³, and still more specifically between 300 Kg/m³ and 500 Kg/m³.

In a preferred embodiment of the method according to the invention, the step of feeding the first quantity is carried out in full before starting the step of mixing. In addition, the steps of feeding the second quantity of at least one dry product and of mixing the second quantity of dry product with the first quantity of liquid are carried out by feeding the dry product in two separate sub-steps, and mixing them between one sub-step and the other: preferably, the percentage of the dry product fed during the first sub-step is between 20% and 40%, more preferably approximately 30% of the total quantity, and the rest of the dry product is fed during the second sub-step.

In other words, once the first portion of the second quantity of dry product is fed into the kneader 100, it is mixed with the first quantity of the at least one liquid by the kneader 100 for a predetermined length of time to obtain a first, diluted mixture. After that, the second portion of the second quantity of dry product is also added into the kneader 100 and mixed with the diluted mixture so as to obtain the aforesaid mixture.

In an alternative embodiment of the method, the steps of feeding the first quantity of at least one liquid and the second quantity of at least one dry product and the step of mixing the second quantity of dry product with the first quantity of liquid are carried out by feeding the liquid and the dry product in two separate sub-steps, and mixing them between one sub-step and the other.

In other words, both the at least one liquid and the at least one dry product are fed in two distinct steps, with one or more intermediate steps of mixing between one and the other, so as to optimally blend the components.

In a further alternative embodiment of the method, the step of feeding the second quantity of the at least one dry product is carried out before the step of mixing. In addition, the steps of feeding the first quantity of at least one liquid and of mixing the second quantity of dry product with the first quantity of liquid are carried out by feeding the liquid in two separate sub-steps, and mixing them between one sub-step and the other.

Irrespective of how the steps of feeding and mixing are carried out, once the step of mixing is over, the method comprises forming a continuous web N by laminating the mixture thus obtained.

In particular, according to an aspect peculiar to this invention, the step of forming the continuous web N comprises performing a first step of laminating the mixture via a first pair of rollers 200 to obtain a laminated semi-finished product, and then performing a second step of laminating the laminated semi-finished product via a second pair of rollers 300 to obtain a continuous web N.

Preferably, the mixture produced by the step of mixing is sent directly to the first pair of rollers 200, preferably by gravity (or by tilting) to carry out the first step of laminating. In other words, there are no intermediate steps between the step of mixing the first step, of laminating carried out by the first pair of rollers 200.

According to an aspect of this invention, at least one between the first step of laminating and the second step of laminating is a step of vertical lamination. Preferably, both the first and the second step of laminating are steps of vertical lamination. For this purpose, the plant 1 comprises a first pair of rollers 200, configured to perform vertical lamination, and a second pair of rollers 300, configured to perform vertical lamination.

According to an aspect of the invention, the method comprises a step of scraping the semi-finished product off the first pair of rollers 200 and feeding the semi-finished product to the second pair of rollers 300, in particular by gravity or by conveying it. For this purpose, the plant 1 may comprise one or more scraping tools 400, such as blades, for example, connected to the first pair of rollers 200 and configured to perform said step of scraping.

In effect, it has been noticed that in the case of cellulose-based mixtures, specifically with particular percentages of moisture content and cellulose fraction, the laminated semi-finished product leaving the first pair of rollers 200 has an irregular texture, in particular, a flaky texture.

The expression “flaky texture” as used in this description means a semi-finished product broken into a plurality of fragments which are irregular in shape and have a plate-like structure.

The second pair of rollers 300 therefore has the function of gathering the flakes and re-laminating them to obtain a smooth, continuous web.

The two pairs of rollers 200, 300 therefore have the function of converting the grainy mixture into a continuous web.

According to an aspect of the invention, the method may also comprise, after the second step of laminating, a step of multi-stage laminating, preferably horizontal, to reduce the thickness of the continuous web N in controlled manner until reaching a calibrated thickness value. For this purpose, the plant 1 may comprise a plurality of pairs of horizontal laminating rollers 400 mounted in series along a laminating path, the pairs of horizontal rollers 400 delimiting between them a passage which becomes progressively narrower to gradually reduce the thickness of the web N made.

Preferably, after completing the step of multi-stage laminating, the web has a thickness of between 180 μm and 270 μm and still more preferably, between 210 μm and 250 μm.

Once the web N has been made, the method further comprises a step of drying to obtain a continuous, dry web N. For this purpose, the plant may comprise a drying device 500.

Preferably, the dry web N has a density of between 0.60 g/cm³ and 1.1 g/cm³ , preferably between 0.75 g/cm³ and 0.90 g/cm³.

The invention achieves the preset aims overcoming the drawbacks of the prior art.

In particular, the method of the invention allows making a continuous web N of satisfactory quality from plant cellulose-based material. This result is achieved in particular by subjecting the mixture to a double vertical lamination, preferably alternated with a step of scraping the semifinished product off the surfaces of the first pair of laminating rollers 200. Moreover, the method of this invention can be implemented using a compact and structurally simplified plant 1, which is also advantageous in terms of operating energy consumption.

1. A method for making a continuous web from cellulose-based material, comprising the following steps:
a step of feeding a first quantity of at least one liquid into a mixing space of a kneader;
a step of feeding a second quantity of at least one dry product into the mixing space of the kneader; the at least one dry product comprising cellulose in fibre and/or ground or powdered form;
a step of mixing the second quantity of dry product with the first quantity of liquid in the kneader to obtain a mixture, where said mixture has a moisture content of between 10% and 65%, preferably between 15% and 35%, more preferably between 20% and 30% and still more preferably, approximately 25%, and a cellulose content of between 40% and 80%, preferably between 40% and 65%, more preferably between 50% and 60% and still more preferably, approximately 55%;
a subsequent step of forming a continuous web from said mixture,
wherein said step of forming a continuous web comprises the following sub-steps:
performing a first step of laminating the mixture via a first pair of rollers to obtain a laminated semi-finished product;
performing a second step of laminating the laminated semi-finished product via a second pair of rollers to obtain a continuous web.

2. The method according to claim 1, wherein the first and/or the second step of laminating is a step of vertical laminating.

3. The method according to claim 1, comprising, between the steps of laminating, a step of scraping the semi-finished product off the first pair of rollers and, once it has been scraped off, feeding the semi-finished product, in particular by gravity, to the second pair of rollers

4. The method according to claim 1, wherein the semi-finished product leaving the first pair of rollers, in particular, scraped off the first pair of rollers, has a flaky structure.

5. The method according to claim 1, wherein the mixture produced by the step of mixing has a sandy and/or grainy texture, with a particle size of between 1 and 6 mm.

6. The method according to claim 1, wherein the mixture produced by the step of mixing is sent directly to the first pair of rollers, preferably by gravity feed or by a conveyor, where the first step of laminating can be carried out.

7. The method according to claim 1, wherein the mixture has a density of between 250 kg/m³ and 500 kg/m³, preferably between 300 kg/m³ and 500 kg/m³.

8. The method according to claim 1, wherein the first quantity of at least one liquid comprises water and, preferably, at least one additional component preferably pre-mixed with the water, the additional liquid comprising one or more between glycerine, nicotine, lactic acid, propylene glycol, colourants and at least one binding agent.

9. The method according to claim 1, wherein the steps of feeding a second quantity of at least one dry product and of mixing the second quantity of dry product with the first quantity of liquid are carried out by feeding the dry product in two separate sub-steps, and mixing them between one sub-step and the other; preferably, the percentage of the dry product fed during the first sub-step being between 20% and 40%, more preferably approximately 30%, and the rest of the dry product being fed during the second sub-step.

10. The method according to claim 1, further comprising, after the second step of laminating, a step of multi-stage laminating, preferably horizontal, to reduce the thickness of the continuous web in controlled manner until reaching a calibrated thickness value.

11. The method according to claim 1. further comprising a step of drying to obtain a dry continuous web.

12. The method according to claim 11, wherein the dry web has a density of between 0.60 g/cm³ and 1.1 g/cm³ , preferably between 0.75 g/cm³ and 0.90 g/cm³ .
